(19) United States
(12) Patent Application Publication
(10) Pub. No.: US 2008/0157604 A1
(43) Pub. Date: Jul. 3, 2008

(54) Control circuit with manual/remote control function

(75) Inventor: Ren-Horng You, Shanhua Township (TW)

Correspondence Address: RABIN & Berdo, PC, 1101 14TH STREET, NW, SUITE 500, WASHINGTON, DC, 20005, US

(73) Assignee: INSTITUTE FOR INFORMATION INDUSTRY, Taipei City (TW)

(21) Appl. No.: 11/723,270

(22) Filed: Mar. 19, 2007

(30) Foreign Application Priority Data
Dec. 13, 2006 (TW) 095146763

(51) Int. Cl. H02B 1/24

(52) U.S. Cl. 307/114; 307/139

(57) ABSTRACT

A control circuit with manual/remote control function is serially connected to a power supply for providing electric power and a load. The control circuit includes a three-way switch having a switching key, a signal indicator module, and a remote control module. The three-way switch and the remote control module are serially connected between the power supply and the load. When the three-way switch is pressed down or the remote control module receives a wireless signal sent from the signal indicator module, the three-way switch or the remote control module is switched to form a closed/open circuit between the power supply and the load, so as to control the state of the load by conveying/stopping supplying the electric power, thereby achieving the purpose of controlling the load via a distal remote control and a proximal manual control.

### CROSS-REFERENCE TO RELATED APPLICATIONS

This non-provisional application claims priority under 35 U.S.C. §119(a) on Patent Application No(s). 095146763 filed in Taiwan, R.O.C. on Dec. 13, 2006, the entire contents of which are hereby incorporated by reference.

### BACKGROUND OF THE INVENTION

1. Field of Invention

The present invention relates to a control circuit, and more particularly, to a control circuit that is capable of controlling a load operation via a distal remote control and a proximal manual control.

2. Related Art

Referring to FIG. 1, it is a circuit structural view of a distal/proximal manipulation circuit of the prior art, which includes a remote control device 110 and a switching device 120.

The remote control device 110 and the switching device 120 are disposed in a manipulation loop 100. The manipulation loop 100 further includes a load 101 and a power supply 102. The remote control device 110 has a control module 111 and a switching module 112, and forms a switching loop by serially connecting the control module 111 to the switching device 120 and the power supply 102. Then, the control module 111 is- further serially connected to the switching module 112 and the load 101 to form a load loop.

When the switching device 120 is operated, the voltage of the switching loop changes, and upon detecting a change in the voltage of the switching loop, the control module 111 controls the switching module 112 to switch to make the load loop closed, such that the load 101 receives the electric power supplied by the power supply 102 to be activated, or to make the load loop open, such that the load 101 stops being operated, as the electric power from the power supply 102 is cut off.

In addition, the control module 111 receives a wireless signal. Once receiving the wireless signal before detecting any change in the voltage of the switching loop, the control module 111 controls the switching module 112 to switch to make the load loop closed or open.

Moreover, to avoid making the switching loop become an open circuit due to turning off the switching device 120, which may cause the remote control module 110 unable to obtain the electric power from the power supply 102 and thus the control module 111 cannot receive the external wireless signal, the switching device 120 is designed into an uninterruptible switch. The uninterruptible switch is formed by a rebound key 121 and a capacitor 122 connected in parallel. If the rebound key 121 is pressed down, the electric power of the power supply 102 is conducted to the capacitor 122 for charging it and changing the voltage of the switching loop. After the voltage changes, the remained voltage of the switching loop is still sufficient to maintain the continuous operation of the control module 111, and the rebound key 121 is bounced back to the original position after being released, so as to keep the switching loop as closed.

However, the manipulation circuit in the prior art still has unavoidable disadvantages, that is, in terms of both manual control and wireless remote control, a control module is employed to receive an external wireless signal or to detect a change in the voltage of the switching loop, moreover, the operation of the switching module is controlled by the control module, and if the control module is damaged, the manipulation circuit will be failed completely, and thus the load cannot be manipulated via either manual or remote control processes.

### SUMMARY OF THE INVENTION

Accordingly, in order to solve the above problems, the present invention provides a control circuit for controlling the load, which aims at providing two control manners respectively through a remote control module and a manual control module in a control circuit to control the ON/OFF of the load, and if the remote control module is damaged, the manual control module still can be used to continuously control the operation of the load.

The present invention provides a control circuit with manual/remote control function, which is electrically connected to a power supply for providing electric power and a load. The control circuit comprises a three-way switch, a signal indicator module, and a remote control module, wherein the three-way switch and the remote control module are serially connected between the power supply and the load.

The signal indicator module sends a wireless signal. The three-way switch is used to transmit the electric power supplied from the power supply. The three-way switch has a switching key, wherein if the switching key is pressed down, the three-way switch switches a transmission path of the electric power. The remote control module receives the wireless signal sent by the signal indicator module, and has a single pole double throw switch. The single pole double throw switch is serially connected between the power supply and the load, and it is electrically connected to the three-way switch. Once the remote control module receives the wireless signal, the single pole double throw switch is actuated, such that the single pole double throw switch and the three-way switch are switched between two different states, ON and OFF states. When the remote control module and the three-way switch are switched to the ON state, the remote control module conducts the electric power of the power supply to activate the load, and when they are switched to the OFF state, the remote control module cuts off the electric power of the power supply, thus stopping the operation of the load.

Moreover, if the switching key of the three-way switch is pressed down, the transmission path of the electric power is switched, and the three-way switch and the remote control module are switched between the ON/OFF states.

The remote control module further has a signal processing unit for receiving a wireless signal and actuating the single pole double throw switch upon receiving the wireless signal, so as to make the three-way switch and the single pole double throw switch be switched between the ON/OFF states.

The control circuit provided by the present invention further comprises a four-way switch serially connected between the three-way switch and the single pole double throw switch. The four-way switch has a conversion key, and if the conversion key is pressed down, the three-way switch and the single pole double throw switch are switched between the ON/OFF states.

The control circuit provided by the present invention further comprises at least two four-way switches serially connected between the three-way switch and the single pole double throw switch. The four-way switches respectively have a conversion key. One of the four-way switches is connected to the three-way switch, and the other is connected to the single pole double throw switch. If the conversion key of any of the four-way switches is pressed down, the three-way switch and the single pole double throw switch are switched between two different states, ON/OFF states.

Furthermore, the aforementioned signal processing unit is a wireless signal receiver, and the signal indicator module is an wireless signal transmitter.

The present invention has an efficacy that cannot be achieved in the prior art. That is, as seen from the connection features of the three-way switch, the three-way switch and the single pole double throw switch have two different power transmission paths when they are connected. However, the single pole double throw switch is controlled by the signal processing unit, and the three-way switch has a manually-controlled switching key. No matter the first or single pole double throw switch is actuated, the load and the power supply are switched between the ON/OFF states.

Therefore, when the signal processing unit is damaged, the single pole double throw switch can still maintain one of the two power transmission paths. The user employs the three-way switch to switch the transmission paths of the electric power, so as to form ON/OFF states between the first and single pole double throw switches, and thus making the load and the power supply form a closed or open circuit. Therefore, if the remote control manner fails, the manual control process can be adopted to continuously control the operations of the load.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a circuit structural view of a distal/proximal manipulation circuit in the prior art;

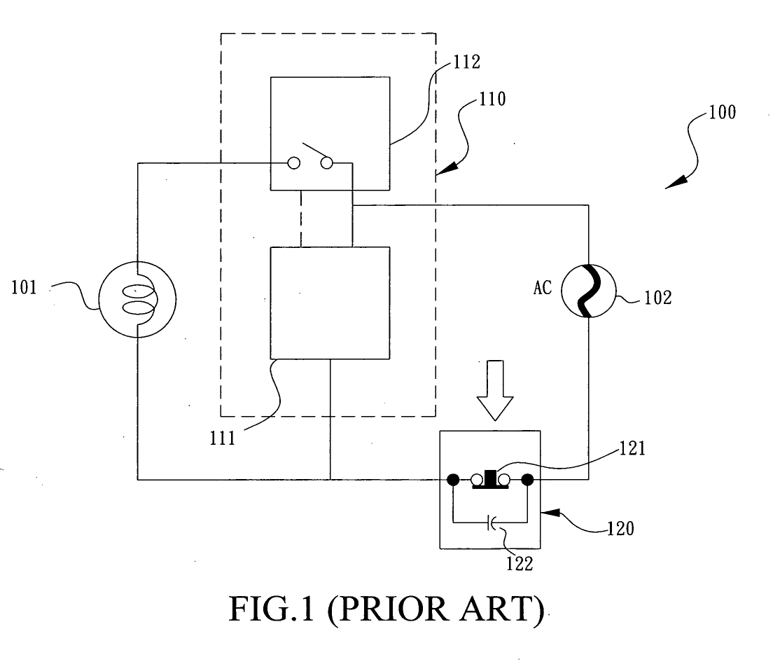

FIG. 2 is a circuit structural view of a first embodiment of the present invention;

FIG. 3A is a schematic view of a three-way switch being turned on through manual control according to the present invention;

FIG. 3B is a schematic view of the three-way switch being turned off through manual control according to the present invention;

FIG. 4A is a schematic view of a single pole double throw switch turned on through remote control according to the present invention;

FIG. 4B is a schematic view of the single pole double throw switch turned off through remote control according to the present invention;

FIG. 5A is a schematic view of the process of turning on through manual control according to a second embodiment of the present invention;

FIG. 5B is a schematic view of the process of turning off through manual control according to the second embodiment of the present invention; and

FIG. 6 is a circuit structural view of a third embodiment of the present invention.

### DETAILED DESCRIPTION OF THE INVENTION

To make the objectives, structural features, and functions of the present invention be further understood, the present invention will be illustrated in detail below through relevant embodiments and accompanying drawings.

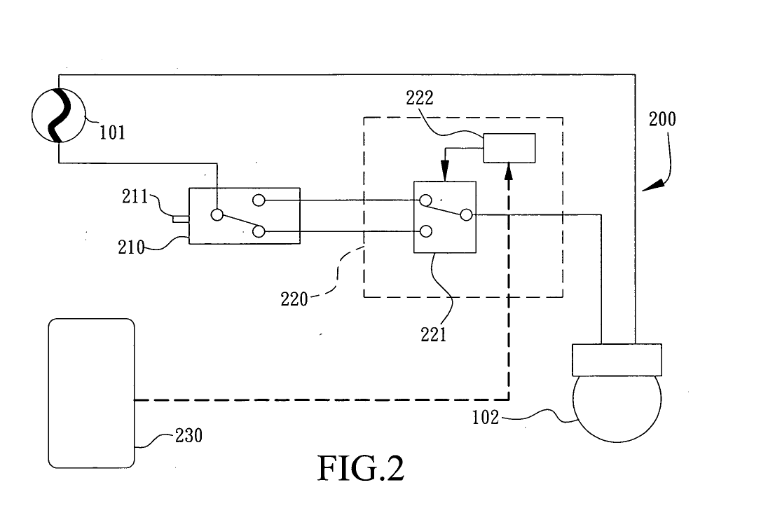

Referring to FIG. 2, it is a circuit structural view of a first embodiment of the present invention, which includes a load circuit 200. The basic structure of the load circuit 200 includes a signal indicator module 230, a three-way switch 210, a remote control module 220, a load 101, and a power supply 102, wherein the power supply 102 supplies an electric power to activate the load 101.

In this embodiment, the remote control module 220 has a single pole double throw switch 221 and a signal processing unit 222. The three-way switch 210 and the single pole double throw switch 221 are electrically connected to each other, so as to establish two different power transmission paths. The three-way switch 210 is electrically connected to the power supply 102, for transmitting the electric power provided by the power supply 102. The single pole double throw switch 221 is electrically connected to the load 101. The power supply 102, the three-way switch 210, the single pole double throw switch 221, and the load 101 are serially connected to form a series circuit. The signal indicator module 230 sends a wireless signal. The signal processing unit 222 is electrically connected to the single pole double throw switch 221 to receive the wireless signal.

The three-way switch 210 further has a switching key 211. Under the circumstance of manual control, when the user presses down the switching key 211, the three-way switch 210 is switched between the two power transmission paths, so as to alter the conducting path of the electric power, and thus making the three-way switch 210 and the single pole double throw switch 221 be switched between two states of ON/OFF states.

Under the circumstance of distal remote control, the user uses the signal indicator module 230 to send a wireless signal, which is received by the signal processing unit 222. After receiving the wireless signal, the signal processing unit 222 actuates the single pole double throw switch 221. The single pole double throw switch 221 is switched between the two different power transmission paths to alter the conducting path of the electric power, such that the single pole double throw switch 221 and the three-way switch 210 are switched between the ON/OFF states.

When the three-way switch 210 and the single pole double throw switch 221 are turned on, the power supply 102 and the load 101 form a closed circuit. The electric power supplied by the power supply 102 can be conducted to the load 101 for activating the load 101. When the three-way switch 210 and the single pole double throw switch 221 are turned off, the power supply 102 and the load 101 form an open circuit, and thus the load 101 stops being operated, as the electric power from the power supply 102 is cut off.

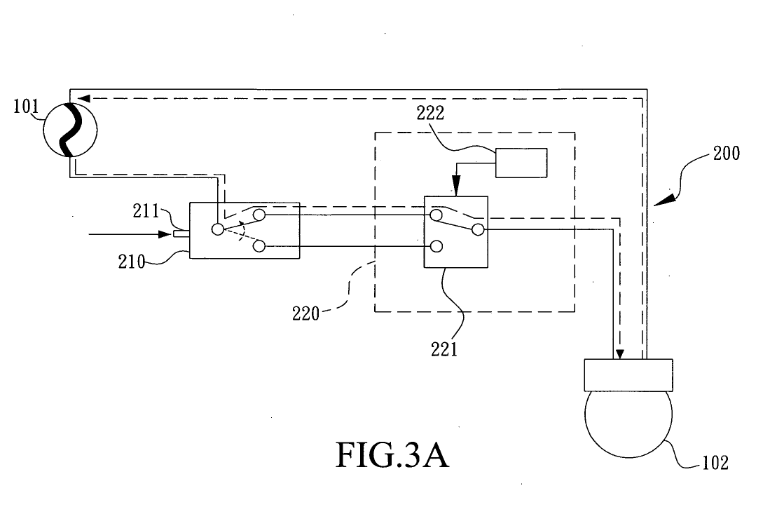

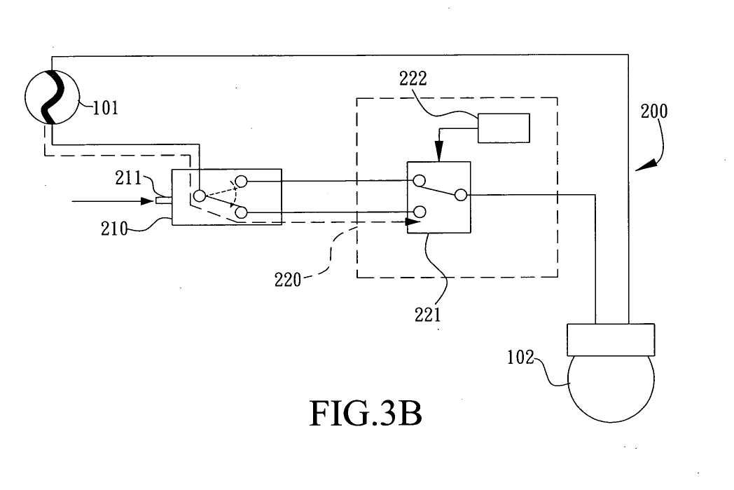

Referring to FIG. 3A, it is a schematic view of the first and single pole double throw switches turned on through manual control. When the three-way switch 210 and the single pole double throw switch 221 are turned off, if the switching key 211 is pressed down, the three-way switch 210 switches the transmission path of the electric power to alter the conducting path of the electric power. At this time, the three-way switch 210 and the single pole double throw switch 221 are switched to the ON state due to the change of the transmission path, so as to form a closed circuit between the power supply 102 and the load 101. Therefore, the electric power supplied by the power supply 102 is conducted to the load 101 via the three-way switch 210 and the single pole double throw switch 221, and the load 101 is activated, upon obtaining the electric power from the power supply 102.

Referring to FIG. 3B, it is a schematic view of the first and single pole double throw switches turned off through manual control. When the three-way switch 210 and the single pole double throw switch 221 are turned on, if the switching key 211 is pressed down, the three-way switch 210 switches the transmission path of the electric power. At this time, the three-way switch 210 and the single pole double throw switch 221 are switched to the OFF state due to the change of the transmission path. Thus, the power supply 102 and the load 101 form an open circuit, and the load 101 stops being operated, as the electric power from the power supply 102 is cut off.

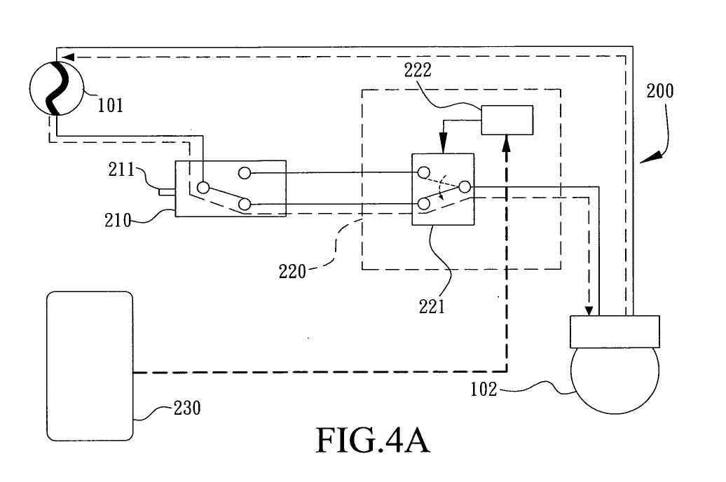

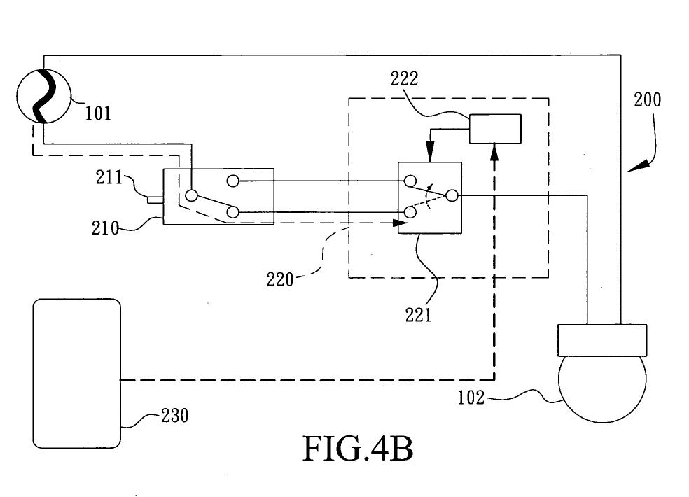

Referring to FIG. 4A, it is a schematic view of the first and single pole double throw switches turned on through remote control according to the present invention. When the three-way switch 210 and the single pole double throw switch 221 are turned off, if the signal processing unit 222 receives the wireless signal sent from the signal indicator module 230, the signal processing unit 222 actuates the single pole double throw switch 221, and the single pole double throw switch 221 switches the transmission path of the electric power, so as to alter the conducting path of the electric power. At this time, the single pole double throw switch 221 and the three-way switch 210 are switched to the ON state due to the change of the transmission path, and thus making the power supply 102 and the load 101 form a closed circuit. Therefore, the electric power supplied by the power supply 102 is conducted to the load 101 via the three-way switch 210 and the single pole double throw switch 221, and thus the load 101 is activated upon receiving the electric power from the power supply 102.

Referring to FIG. 4B, it is a schematic view of the first and single pole double throw switches turned off through remote control. When the three-way switch 210 and the single pole double throw switch 221 are turned on, if the signal processing unit 222 receives the wireless signal sent by the signal indicator module 230, the signal processing unit 222 actuates the single pole double throw switch 221, and the single pole double throw switch 221 switches the transmission path of the electric power to alter the conducting path of the electric power. At this time, the single pole double throw switch 221 and the three-way switch 210 are switched to the OFF state due to the change of the transmission path. Thus, the power supply 102 and the load 101 form an open circuit, and the load 101 stops being operated, as the electric power from the power supply 102 is cut off.

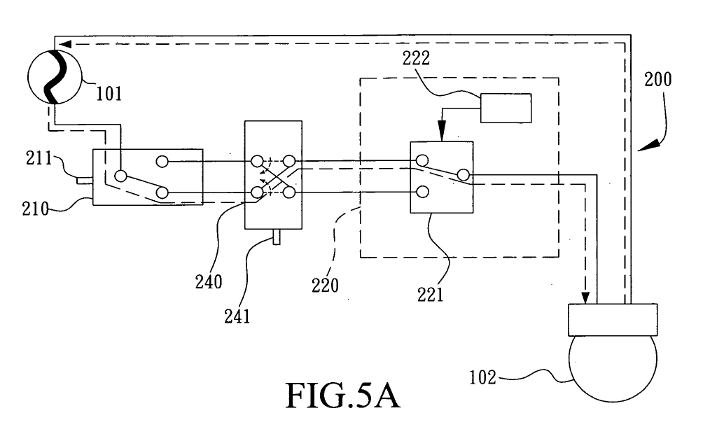

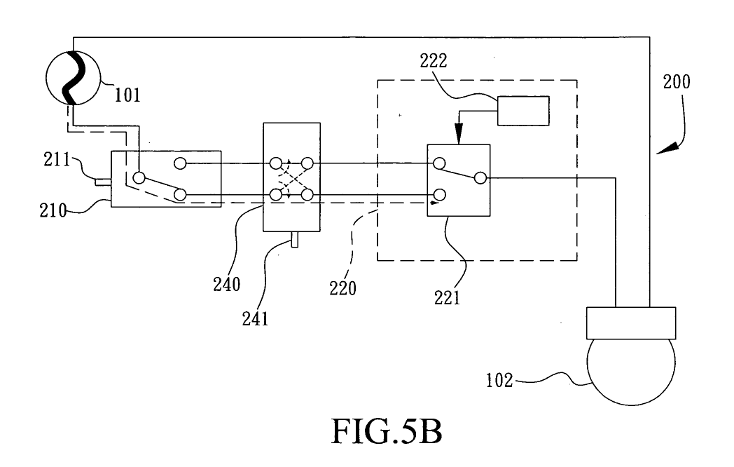

Referring to FIG. 5A, it is a schematic view of the process of turning on through manual control according to a second embodiment of the present invention. The difference between the second embodiment and the aforementioned first embodiment lies in that, a first four-way switch 240 is serially connected between the three-way switch 210 and the single pole double throw switch 221.

The first four-way switch 240 has a conversion key 241. If the conversion key 241 is pressed down, the first four-way switch 240 converts a circuit configured therein, so as to make the three-way switch 210 and the single pole double throw switch 221 be switched between the ON/OFF states.

This embodiment takes the three-way switch 210 and the single pole double throw switch 221 being in the OFF state as a precondition. When the conversion key 241 of the first four-way switch 240 is pressed down, the first four-way switch 240 converts the parallel internal lines into crossed internal lines. At this time, the three-way switch 210 and the single pole double throw switch 221 are communicated with each other due to the conversion of the internal lines of the first four-way switch 240. Therefore, the electric power supplied by the power supply 102 is conducted to the load 101 via the three-way switch 210, the first four-way switch 240, and the single pole double throw switch 221.

Referring to FIG. 5B, it is a schematic view of the process of turning off through manual control according to the second embodiment of the present invention.

This embodiment takes the three-way switch 210 and the single pole double throw switch 221 being in the ON state as a precondition. When the conversion key 241 of the first four-way switch 240 is pressed down, the first four-way switch 240 converts the crossed internal lines into parallel internal lines. At this time, the three-way switch 210 and the single pole double throw switch 221 are turned off due to the conversion of the internal lines of the first four-way switch 240. Therefore, the load 101 stops being operated, as the electric power supplied by the power supply 102 is cut off.

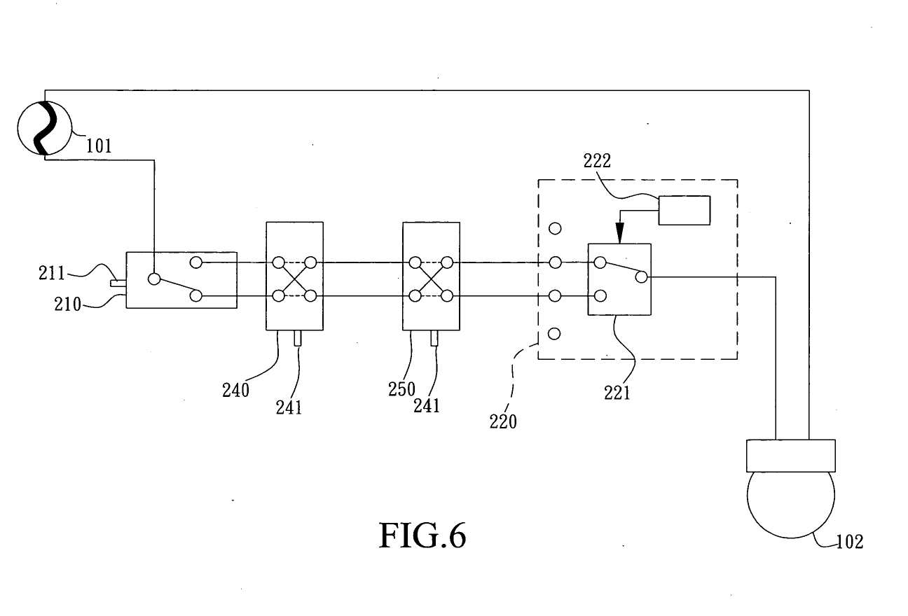

Referring to FIG. 6, it is a circuit structural view of a third embodiment of the present invention. A first four-way switch 240 and a second four-way switch 250 are serially connected between the three-way switch 210 and the single pole double throw switch 221 in sequence, and the first four-way switch 240 and the second four-way switch 250 both have a conversion key 241. The first four-way switch 240 is electrically connected to the three-way switch 210, and the second four-way switch 250 is electrically connected to the single pole double throw switch 221.

With the feature of a four-way switch that the internal line configuration can be altered by pressing down the conversion key, the three-way switch 210 and the single pole double throw switch 221 can be switched between the ON/OFF state, if the conversion key 241 of any of the first four-way switch 240 and the second four-way switch 250 is pressed down.

In this way, if the user intends to manually control the operations of the load at M positions, merely (M-1) four-way switches are required for being serially connected between the three-way switch and the remote control module (as the three-way switch takes up one of the positions). For example, to proximal manual control the load at three positions, the configuration of the three-way switch must be first removed, and (3-1) four-way switches have to be serially connected. That is, two more four-way switches must be further configured to meet the requirement of proximal manual control at three positions. If the remote control module is also adopted to perform the distal manipulation of the load, the purpose of both proximal control and distal remote control of the load at a plurality of positions can be fulfilled.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A control circuit with manual/remote control function, electrically connected to a power supply and a load, wherein the power supply provides an electric power; and the control circuit controls the conduction of the electric power to control operations of the load, the control circuit comprising:
a three-way switch, serially connected between the power supply and the load, for conducting the electric power, and having a switching key, wherein a transmission path of the electric power is switched by pressing down the switching key;
a signal indicator module, for sending a wireless signal; and
a remote control module, having a single pole double throw switch serially connected between the power supply and the load, and electrically connected to the three-way switch, wherein upon receiving the wireless signal, the remote control module actuates the single pole double throw switch to make the single pole double throw switch and the three-way switch be switched between an On state and an OFF state, at the On state, the electric power is conducted to activate the load; whereas in the OFF state, the electric power is cut off to stop the load.

2. The control circuit as claimed in claim 1, wherein if the switching key of the three-way switch is pressed down, the three-way switch is used to switch the transmission path of the electric power, so as to make the three-way switch and the remote control module be switched between the ON and OFF states.

3. The control circuit as claimed in claim 2, wherein the remote control module further comprises a signal processing unit for receiving the wireless signal, and actuating the single pole double throw switch after receiving the wireless signal.

4. The control circuit as claimed in claim 3, further comprising a first four-way switch having a conversion key and being serially connected between the three-way switch and the single pole double throw switch, wherein if the conversion key is pressed down, the three-way switch and the single pole double throw switch are switched between two different states, ON and OFF states.

5. The control circuit as claimed in claim 3, further comprising at least one second four-way switch having a conversion key, wherein the first four-way switch and the second four-way switch are serially connected between the three-way switch and the single pole double throw switch in sequence; the first four-way switch is connected to the three-way switch, the second four-way switch is connected to the single pole double throw switch; and if the conversion key of the first/second four-way switch is pressed down, the three-way switch and the single pole double throw switch are switched between the ON and OFF states.

6. The control circuit as claimed in claim 3, wherein the signal processing unit is a wireless signal receiver, and the signal indicator module is a wireless signal transmitter.
